(19) United States
(12) Patent Application Publication
(10) Pub. No.: US 2005/0169300 A1
(43) Pub. Date: Aug. 4, 2005

(54) APPARATUS AND RELATED METHOD FOR SERIALLY IMPLEMENTING DATA TRANSMISSION

(76) Inventors: Po-Wei Liu, Tai-Nan City (TW); Jung-You Feng, Hsin-Chu City (TW); Chen-Chih Huang, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/906,089

(22) Filed: Feb. 2, 2005

(30) Foreign Application Priority Data
Feb. 4, 2004 (TW) 093102487

(51) Int. Cl. H04L 12/66

(52) U.S. Cl. 370/463

(57) ABSTRACT

A network interface includes a first network layer and a second network layer. The apparatus includes a first serial interface coupled to the first network layer and a second serial interface coupled to the second network layer. The first serial interface is for converting the first parallel data received from the first network layer into a first serial signal, and outputting the first serial signal serially. The second serial interface is for receiving and converting the first serial signal into the first parallel data, and sending the first parallel data to the second network layer.

### BACKGROUND OF INVENTION

1. Field of the Invention

The present invention relates to a network interface, and more particularly, to a network interface in which data transmission is implemented serially.

2. Description of the Prior Art

Computer networks are under rapid development. Generally speaking, the network hierarchy is composed of a plurality of network layers. For example, a physical link layer (referred to as PHY layer) and a medium access control layer (referred to as MAC layer) are two layers which lie on the bottom of the network hierarchy.

In conventional technologies, data transmission between the PHY layer and the MAC layer is implemented in a parallel way under a pre-defined protocol, such as media independent interface (MII) or reduced media independent interface (reduced MII). If the PHY layer and the MAC layer are implemented in two different chips, a great amount of pins are required. On the other hand, if the PHY layer and the MAC layer are implemented within the same chip, the layout of the PHY layer and the MAC layer is complicated. This may affect the performance and size of the chip.

Presently, for systems having multi-gigabit bandwidth, no matter whether gigabit media independent interface (GMII) or reduced gigabit media independent interface (reduced GMII) is used as the parallel transmission interface between the PHY layer and the MAC layer, more and more pins are required. This is undesirable from the viewpoint of cost and system deployment.

### SUMMARY OF INVENTION

It is therefore one of the many objectives of the present invention to provide a network interface in which data transmission is implemented serially.

According to the claimed invention, the network interface includes a first network layer and a second network layer, wherein the first network layer outputs a first parallel data, and the second network layer receives the first parallel data. The apparatus includes a first serial interface, coupled to the first network layer for converting the first parallel data received from the first network layer into a first serial signal, and outputting the first serial signal serially; and a second serial interface coupled to the second network layer for receiving the first serial signal, converting the first serial signal into the first parallel data, and outputting the first parallel data to the second network layer.

According to the claimed invention, the method is capable of implementing data transmission via a network interface serially. The network interface includes a first network layer and a second network layer. The method includes:
receiving and converting a first parallel data from the first network layer into a first serial signal;
serially transferring the first serial signal;
serially receiving the first serial signal; and
converting the first serial signal into the first parallel data.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a network interface according to the present invention.

FIG. 2 illustrates a detailed block diagram of an embodiment of the SERDES in FIG. 1 according to the present invention.

### DETAILED DESCRIPTION

Since a parallel transmission interface requires a great amount of pins for coupling to the PHY layer and the MAC layer, the present invention adopts a serial interface to couple to the PHY layer and the MAC layer serially.

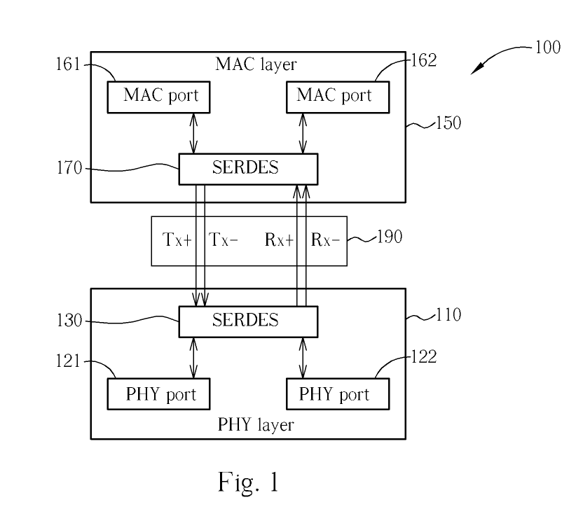

Please refer to FIG. 1. FIG. 1 is a schematic diagram of a network interface 100 according to an embodiment of the present invention. The network interface 100 includes a PHY layer 110 and a MAC layer 150. The PHY layer 110 and the MAC layer 150 are coupled to each other via a serial interface 190. In an embodiment, the PHY layer 110 includes a serializer/deserializer (SERDES) 130 and at least one PHY port, and the MAC layer 150 includes a serializer/deserializer (SERDES) 170 and at least one MAC port. The serial interface 190 includes differential transmitting pairs Tx+ and Tx−, and differential receiving pairs Rx+ and Rx−.

In FIG. 1, the PHY layer 220 includes two PHY ports 121 and 122, and the MAC layer includes two MAC ports 161 and 162. In order to deliver the parallel data generated by the PHY ports 121 and 122 or by the MAC ports 161 and 162, the PHY ports 121 and 122 share the SERDES 130 so as to convert the parallel data generated by the PHY ports 121 and 122 into serial signal, and deliver the serial signal to the MAC layer 150 via the serial interface 190, or convert the serial signal received via the serial interface 190 into parallel data, and deliver the parallel data to the PHY ports 121 and 122. Similarly, the MAC ports 161 and 162 share the (SERDES) 170 so as to convert the parallel data generated by the PHY ports 161 and 162 into serial signal, and deliver the serial signal to the PHY layer 110 via the serial interface 190, or convert the serial signal received via the serial interface 190 into parallel data, and deliver the parallel data to the MAC ports 161 and 162. It is noted that the data transmission rate between the SERDES 130 and the SERDES 170 is determined according to the requirements of the quality of data transmission of the network system. For example, data transmission between the SERDES 130 and the SERDES 170 shown in FIG. 1 can reach 2.5 gigabit per second to match a network system having a multi-gigabit bandwidth.

Though the PHY ports 121 and 122 share a SERDES 130, and the MAC ports 161 and 162 share the SERDES 170 in this embodiment. In practice, however, the network interface 100 can be designed to have N PHY ports which share a SERDES, and N MAC ports which share another SERDES, where N may equal 2 or any positive integer.

In addition, a quantity of PHY ports contained in the PHY layer (and a quantity of MAC ports contained in the MAC layer) is usually larger than two. Therefore, the network interface can be modified so that each two PHY ports of the PHY layer and each two MAC ports of the MAC layer can share a set of SERDES (having a SERDES of the PHY layer and a SERDES of the MAC layer), where the data transmission rate between the set of SERDES is 2.5 gigabit per second. If the quantity of PHY ports contained in the PHY layer (or the quantity of MAC ports contained in the MAC layer) is odd, the remaining one PHY port and the corresponding MAC port can share a set of SERDES (having a SERDES of the PHY layer and a SERDES of the MAC layer), where the data transmission rate between the set of SERDES is 1.25 gigabit per second.

Furthermore, if the PHY ports (or the MAC ports) use an 8-bit interface, data of each two PHY ports can be converted to 20-bit data via an 8-to-10-bit converting interface. The 20-bit data is then transmitted to a SERDES via a 20-bit interface for converting the 20-bit parallel data into serial signal. The serial signal is then transmitted to another SERDES of the MAC layer for transformation into parallel data.

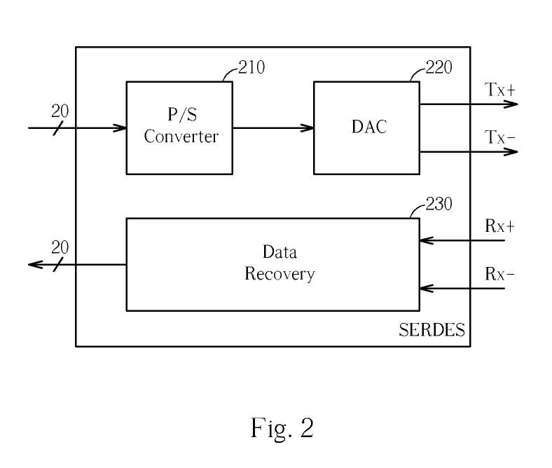

Please refer to FIG. 2. FIG. 2 illustrates a detailed block diagram of an embodiment of the SERDES according to the invention. In an embodiment, each of the SERDES 170 and the SERDES 130 includes a Parallel-to-Serial (P/S) Converter 210, a DAC 220, and a Data recovery 230. The P/S converter 210 is used for converting 20-bit data into a serial signal. The DAC 220 is used for converting the serial signal into an analog signal (TX+ and Tx−) and outputting the analog signal (TX+ and Tx−) to another SERDES. The Data recovery 230 is used for receiving an analog signal (Rx+ and Rx−) from another SERDES, over-sampling the received signal, and producing the digital signal to the MAC port or PHY port.

In an embodiment, the SERDES 170 alternately receives the digital signal from MAC port 161 and the MAC port 162. The SERDES 170 transmits the analog signal (Tx+ and Tx−), and the SERDES 130 receives the analog signal from the SERDES 170, producing the digital signal according to the analog signal from the SERDES 170, and alternately outputs the digital signal into the PHY port 121 and the PHY port 122. In an embodiment, the SERDES 170 can produce a control codeword to the SERDES 130 and the SERDES 130 can transfer the digital signal into the PHY port 121 or the PHY port 122 according to the control codeword. In a preferred embodiment, the analog signal includes the control codeword.

In an embodiment, the SERDES 130 alternately receives the digital signal from PHY port 121 and the PHY port 122. The SERDES 130 transmits the analog signal (Rx+ and Rx−), and the SERDES 170 receives the analog signal from the SERDES 130, producing the digital signal according to the analog signal from the SERDES 130, and alternately outputs the digital signal into the MAC port 161 and the MAC port 162.

In an embodiment, the SERDES 130 can generate a control codeword and transfer the control codeword to the SERDES 170 and the SERDES 170 can transfer the digital signal into the MAC port 161 or the MAC port 162 according to the control codeword. The control codeword is used for informing another SERDES the current digital signal is needed to transfer the MAC port 161 or the MAC port 162.

Those skilled in the art will readily appreciate that numerous modifications and alterations of the device may be made without departing from the scope of the present invention. Accordingly, the above disclosure should be construed as limited only by the metes and bounds of the appended claims.

1. An apparatus for processing data transmission in a network interface, the network interface comprising a first network layer and a second network layer, the first network layer outputting a first parallel data, and the second network layer receiving the first parallel data, the apparatus comprising:
a first serial interface, coupled to the first network layer, for converting the first parallel data received from the first network layer into a first serial signal, and outputting the first serial signal serially; and
a second serial interface, coupled to the second network layer, for receiving the first serial signal from the first serial interface, converting the first serial signal into the first parallel data, and outputting the first parallel data to the second network layer.

2. The apparatus of claim 1 wherein the first network layer is a medium access control layer, and the second network layer is a physical link layer.

3. The apparatus of claim 1
wherein the first serial interface comprises a serializer for converting the first parallel data from the first network layer into the first serial signal; and
wherein the second serial interface comprises a deserializer converting the first serial signal into the first parallel data.

4. The apparatus of claim 3 wherein N first ports of the first network layer and N second ports of the second network layer are coupled to each other via the first and the second serial interfaces.

5. The apparatus of claim 4 wherein N equals 2, data transmission between the first and the second serial interfaces are implemented at a rate of 2.5 gigabits per second.

6. The apparatus of claim 1 wherein the first network layer comprises a first port and a second port, and the second network layer comprises a third port corresponding to the first port, and a fourth port corresponding to the second port.

7. The apparatus of claim 6,
wherein a first portion of the first parallel data is from the first port, and a second portion of the first parallel data is from the second port; and
wherein the third and fourth ports receive the first and second portions of the first parallel data, respectively.

8. The apparatus of claim 6,
wherein a first portion of the first parallel data is from the first port, and a second portion of the first parallel data is from the second port; and
wherein the third and fourth ports receive the first and second portions of the first parallel data according to a control signal of the first serial signal.

9. The apparatus of claim 1, wherein the first serial interface comprises:
a parallel-to-serial converter utilized for converting the first parallel data into a first serial signal; and
a Digital-to-Analog converter utilized for converting the first serial signal into the first analog signal.

10. The apparatus of claim 1, wherein the second serial interface comprises:
a data recovery circuit utilized for converting the first serial signal into the first parallel data.

11. A method of implementing data transmission in a network interface, the network interface comprising a first network layer and a second network layer, the first network layer comprising at least one first port, the second network layer comprising at least one second port corresponding to the at least one first port, the method comprising:
receiving at least one first parallel data from the at least one first port;
converting the at least one first parallel data into a first serial signal;
serially transmitting the first serial signal;
serially receiving the first serial signal;
converting the first serial signal into the at least one first parallel data; and
transferring the at least one first parallel data into the at least one second port.

12. The method of claim 11 wherein the first network layer is a medium access control layer, and the second network layer is a physical link layer.

13. The method of claim 11 wherein the first network layer comprises two first ports and the first serial signal is transmitted at a rate of 2.5 gigabits per second.

14. A method for implementing data transmission in a network interface, the network interface comprising a first network layer and a second network layer, the method comprising the following steps:
receiving a first parallel data from the first network layer;
converting the first parallel data into a first serial signal;
serially transmitting the first serial signal;
serially receiving the first serial signal; and
converting the first serial signal into the first parallel data.

15. The method of claim 14 wherein the first network layer comprises two first ports and the first serial signal is transmitted at a rate of 2.5 gigabits per second.

16. The method of claim 14 wherein the first network layer comprises a first port and a second port, and the second network layer comprises a third port corresponding to the first port, and a fourth port corresponding to the second port.

17. The method of claim 16 wherein a first portion of the first parallel data is from the first port, and a second portion of the first parallel data is from the second port.

18. The method of claim 16 wherein the third and fourth ports receive the first and second portions of the first parallel data, respectively.

19. The method of claim 16 wherein the third and fourth ports receive the first and second portions of the first parallel data according to a control signal of the first serial signal.
